(19) United States
(12) Patent Application Publication
(10) Pub. No.: US 2010/0322084 A1
(43) Pub. Date: Dec. 23, 2010

(54) Method and Device for Transport Delay Analysis

(75) Inventor: Arto Juhani Mahkonen, Helsinki (FI)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/866,515

(22) PCT Filed: Feb. 7, 2008
(86) PCT No.: PCT/SE2008/050151

§ 371 Date: Aug. 6, 2010

(51) Int. Cl. H04L 12/26

(52) U.S. Cl. 370/248

(57) ABSTRACT

The present invention relates to a method and a device for analyzing transport delay between a sender device and a receiver device in a communication system. In particular, the present invention relates to a method for estimating transport delay in a communication system comprising a sender device dividing a frame into segments, wherein each segment is transmitted in a packet with a send time stamp to a receiver device, the method comprising the steps of: receiving and time stamping packets with a receipt time stamp; identifying the relative-position of packets in a frame; calculating the offset of one or more packets in a frame, and performing transport delay analysis based on the send time stamp, the receipt time stamp, and the calculated offset of the one or more packets.

### TECHNICAL FIELD

The present invention relates to a method and a device for analyzing transport delay between a sender device and a receiver device in a communication system.

### BACKGROUND

Delays and their variation in communication systems are important parameters when evaluating and indicating the efficiency of communication systems. Low transport delays and transport delay variations are in general desirable, in particular in real-time applications, such as Video Telephony over IP (VToIP).

The transport delay (inter-arrival jitter) and its variation may be important to analyze for a number of reasons, including:
Optimization of jitter buffer size,
Jitter sensitive target rate adaptation, and
Transport jitter statistics.

In RFC3550, which describes the Real-time Transport Protocol (RTP), an inter-arrival jitter sample (as one embodiment of transport delay analysis) is defined by the following equation:

D_{i,j}=(Rⱼ−Rᵢ)−(Sⱼ−Sᵢ), (1)

where Rⱼ and Rᵢ, are measured arrival time of packets j and i, respectively, and Sⱼ and Sᵢ, are sending times derived from RTP time stamps of packets j and i, respectively.

In Video Telephony over IP (or VToIP) two media components, video and audio (or speech), are transmitted over at least two RTP data streams (one for video and one for audio) in both directions at the same time.

In order to make video transmission at the source smooth, frames are divided into smaller segments like slices or group of blocks (GOBs) in the encoder/sender device. The segments are further encapsulated in separate RTP-packets and transmitted smoothly over the frame interval rather than in bursts. Smooth transmission here means, that the sender device controls the transmission such that the N RTP-packets belonging to the same video frame are transmitted with equal transmission interval ΔT given by

$$Δ T = \frac{{T}_{frame}}{N} , \qquad ( 2 )$$

where T_{frame} is the frame interval time between consecutive video frames.

Various standards describe smooth transmission. For example, 3GPP TS 26.114 recommends that coded pictures should be encoded into individual segments where each individual segment should be encapsulated in one RTP packet smaller than the Maximum Transfer Unit (MTU) size:
For H.263 Profile 0, a Picture Start Code (PSC) or non-empty Group of Block (GOB) header indicates the beginning of such a segment;
For H.263 Profile 3, MPEG-4 (Part 2) Visual, and H.264/MPEG-4 (Part 10) AVC, a slice corresponds to such a segment.

RFC3550 states, that “Several consecutive RTP packets will have equal timestamps, if they are (logically) generated at once, e.g., belong to the same video frame.” If segmented video frames are transmitted smoothly over the frame interval as described above, the actual transmission times of individual RTP-packets deviate from the nominal transmission time indicated by their timestamps Sᵢ. If transport delay is estimated using an inter-arrival jitter sample given by equation (1), then it will be contaminated by the (unknown) difference or offset between the actual transmission time and the nominal transmission time of an individual RTP-packet. This offset (usually named transmission jitter) has nothing to do with transport delay or transport jitter.

The difference between actual sending time and the nominal transmission time indicated by timestamps Sᵢ of packets lead to inaccurate or defective transport delay analysis.

IETF draft “Transmission Time offsets in RTP streams” (http://www.ietf.org/internet-drafts/draft-ietf-avt-rtp-toffset-06.txt) proposes to use the IETF Generic RTP header extension for transmitting offsets Oᵢ, for each packet from the source to the receiver and replace equation (1) with:

D_{i,j}=(Rⱼ−Rᵢ−((Sⱼ+Oᵢ)−(Sᵢ+Oᵢ)) (3)

Using the IETF Generic RTP header extension for transmitting offsets requires extra bandwidth, which is a limited resource.

### SUMMARY

In view of the above, it is an object of the present invention to provide an improved method for determining and analyzing transport delay or transport jitter between a sender and a receiver in a communication system without the need for additional bandwidth.

Accordingly, a method for estimating transport delay in a communication system comprising a transmitter dividing a frame into segments, wherein each segment is transmitted in a packet with a send time stamp to a receiver is provided. The method comprises the steps of receiving and time stamping packets with a receipt time stamp; identifying the relative position of the packets in a frame; calculating the offset of one or more packets in the frame; and performing transport delay analysis based on the send time stamp, the receipt time stamp and the calculated offset of the one or more packets.

It is an important advantage of the present invention that the method does not require additional bandwidth, which in general is a limited resource in communication networks.

According to a further aspect of the present invention, a receiver device is provided, wherein the receiver device may comprise a network interface adapted to receive and time stamp packets with a receipt time stamp, and a processing device adapted to identify the relative position of packets in a frame, calculate the offset of one or more packets in the frame, and perform transport delay analysis based on the send time stamp, the receipt time stamp, and the calculated offset of the one or more packets.

The receiver device may be a mobile terminal or a computer, e.g. portable or stationary.

In an embodiment of the present invention, the receiver device may be a node in the communication system and/or implemented in test equipment for testing the performance of the communication system.

### BRIEF DESCRIPTION OF THE DRAWING

The above and other features and advantages of the present invention will become readily apparent to those skilled in the art by the following detailed description of exemplary embodiments thereof with reference to the attached drawings, in which:

FIG. 1 schematically illustrates an embodiment of the invention, and

FIG. 2 is a flow chart illustrating an embodiment of the method according to the present invention.

### ABBREVIATIONS

A list of abbreviations and expressions employed herein is found below:
GoB: Group of Blocks
IETF: Internet Engineering Task Force
MPEG-4 (AVC): Coding standards
MTU: Maximum Transfer Unit
QCIF: Quarter Common Intermediate Format
RFC3550: Request For Comments 3550, a transport protocol for real-time applications
RTP: Real-time Transport Protocol
VToIP: Video Telephony over IP
3GPP: 3^{rd} Generation Partnership Project
3GPP TS 26.114: Standard for media handling and interaction

### DETAILED DESCRIPTION

The figures are schematic and simplified for clarity, and they merely show details which are essential to the understanding of the invention, while other details have been left out. Throughout, the same reference numerals are used for identical or corresponding parts.

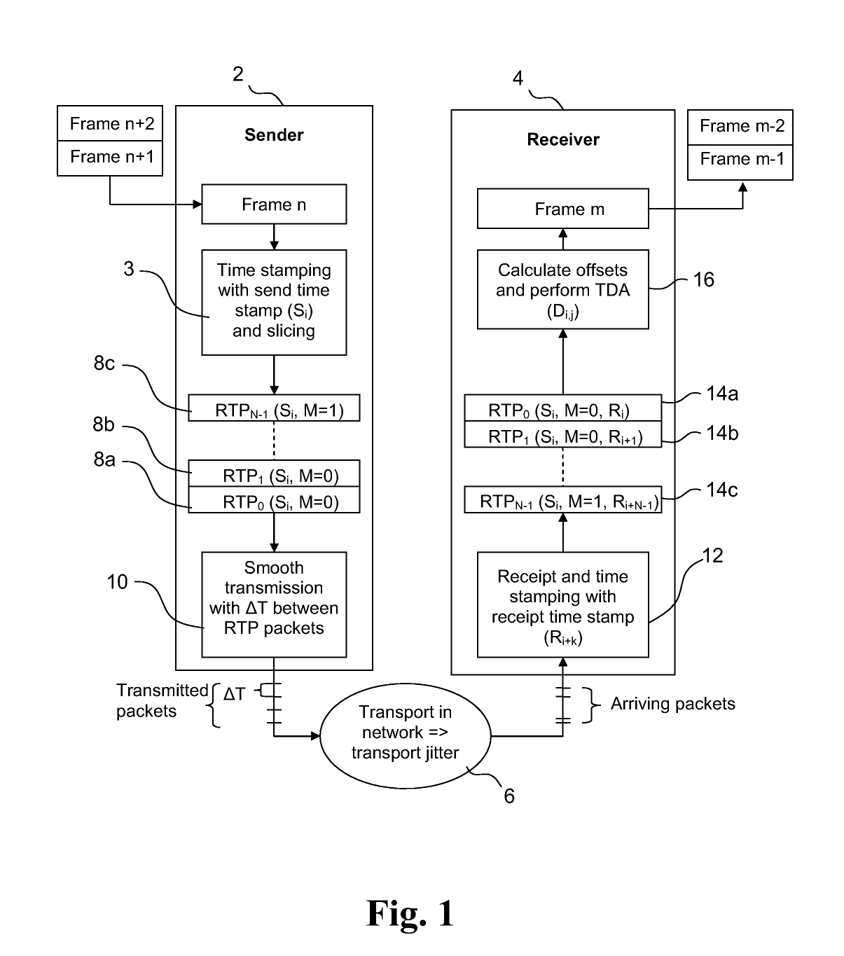

FIG. 1 schematically illustrates an embodiment of the invention. A video and/or audio source (not shown) provides frames to a sender device 2, and the sender device 2 transmits packets to a receiver device 4 via a network 6. The sender device 2 is adapted to transmit packets of video and/or audio frames to the receiver device 4 and comprises a processing unit 3 that is adapted to divide or slice frames, e.g. video frames, in segments that are encapsulated in packets 8a, 8b, 8c. Further, the processing unit 3 may be adapted to perform encoding. The packets from the processing unit are transmitted via a network interface 10, e.g. by smooth transmission. Preferably, the packets are RTP packets, i.e. packets according to the Real-time Transport Protocol (RFC3550).

The method according to the invention takes advantage of inherent properties, e.g. information in mandatory header fields, of packets that are transmitted by smooth transmission from the sender device 2. Accordingly, the method according to the invention provides improved estimate for transport delay or transport jitter when smooth transmission is applied in the sender device. However, smooth transmission is not required.

The receiver device 4 comprises a network interface 12 that is adapted to receive and time stamp each packet with receipt time stamp R. The received packets 14a, 14b, 14c are forwarded to a processing unit 16. The processing unit 16 is adapted to identify the relative position of packets of a frame, e.g. by identifying the last packet of a frame. In case the packets are RTP packets (see RFC3550), the last packet of a frame is indicated by the M-bit in the RTP header field. Furthermore, the processing unit 16 is adapted to calculate the offsets O of the received packets and performing transport delay analysis (TDA) based on the send time stamp S, the receipt time stamp R, and the calculated offset O of the one or more packets. Further, the processing unit 16 may be adapted to perform decoding and/or jitter buffering.

In an embodiment of the present invention, the relative position of packets of a frame may be identified by identifying the first and/or the last packet of a frame.

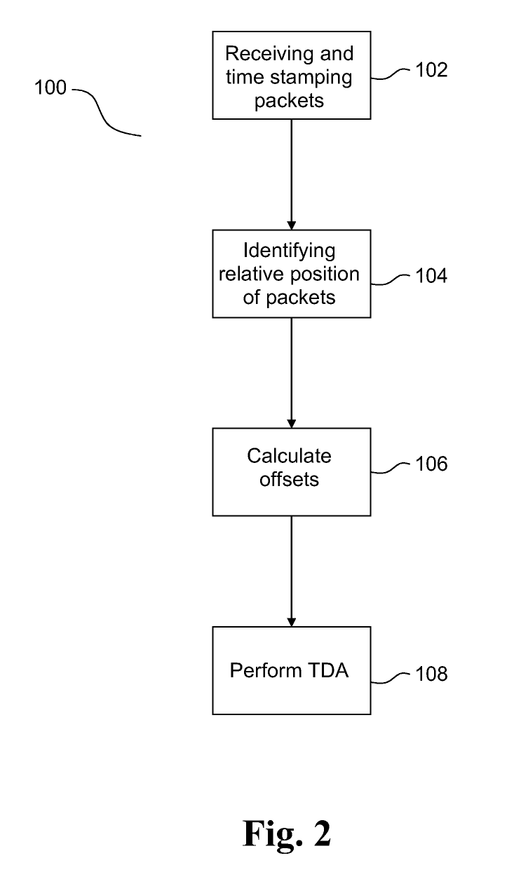

An embodiment of the method according to the invention is illustrated in FIG. 2 showing a flow chart illustrating the different steps of an embodiment of the method. The method 100 for estimating transport delay in a communication system comprising a transmitter or sender device, e.g. sender device 2, dividing a frame into segments, wherein each segment is transmitted in a packet with a send time stamp to a receiver, comprises the step 102 of receiving and time stamping packets with a receipt time stamp. Subsequently, the method proceeds to step 104 of identifying the relative position of the packets in a frame and upon determination of the packet positions, the method 100 continues to the step 106 of calculating the offset of one or more packets in the frame. The calculated offsets of one or more packets at least partly form basis for the improved estimation of the transport delay and its variations (jitter). Upon calculation of offsets, the method 100 continues to the step 108 of performing transport delay analysis based on the send time stamp S, the receipt time stamp R, and the calculated offset O of the one or more packets.

In a preferred embodiment of the present invention, the transport delay analysis is based on the time difference D_{i,j} between transmission times for two packets i and j, wherein D_{i,j} is given by

D_{i,j}=(Rⱼ−Rᵢ)−((Sⱼ+Oⱼ)−(Sᵢ+Oᵢ)),

where Rⱼ and Rᵢ, are receipt time stamps of packets j and i, respectively, Sⱼ and Sᵢ are send time stamps of packets j and i, respectively, and Oⱼ and Oᵢ, are offsets of packets j and i, respectively.

In a preferred embodiment of the present invention, the offset Oᵢ for a packet i is given by

$${O}_{i} = {k}_{i} * \frac{{T}_{frame}}{N} ,$$

where kᵢ, indicates the relative position of the packet i in the frame, T_{frame} is the frame interval, and N is the number of packets in the frame. This embodiment may assume that the sender device uses a smooth transmission method.

Other transmission schemes than smooth transmission, e.g. a regular transmission scheme known to the receiver device, may be applied in the sender device, and in that case the offset calculation may be amended or modified accordingly.

The transport jitter analysis may be based on the formula:

J(i)=J(i−1)+(|D(i−1,i)|J(i−1))/16,

and may be calculated according to the directions given in RFC3550.

It is an important advantage of the present invention that offsets are not transmitted as a part of a packet, but calculated in the receiver part of the network, e.g. in a receiver device, based on inherent information in the packets. In an embodiment of the present information, the calculation of offsets is based on information present in mandatory packet header fields. Thereby, additional fields such as header field extensions requiring extra bandwidth and/or limiting data transfer capacity are not needed. Thus the present invention provides an improved precision in determining transport delay without limiting transmission capacity.

It is a further advantage of the present invention that a more precise estimation of the transport delay variations is provided without requiring additional bandwidth.

In an embodiment of the present invention where the packets are RTP packets, the index kᵢ (kᵢ=0, 1, 2, . . . , N−1) for each packet may be determined as or calculated by the following:

kᵢ=N−P_{M}+Pᵢ,

where N is the number of packets in the frame, P_{M} is the sequence number (mandatory header field) for the last packet (M bit set) in the frame, and Pᵢ, is the sequence number for the packet i. The number of packets in a frame may be any suitable number depending on application and protocol or standard, e.g. one or more, such as two, three, four, five, six, seven, eight, nine, ten, eleven, or more.

For ITU-T standard H.263 Profile 0, a typical video frame rate is ten frames/second and the number N of packets in a frame is for instance nine, when a QCIF frame is divided into 9 GOBs. If offsets (4 bytes each) are to be transmitted as an extension to the header in this case as proposed in IETF draft “Transmission Time offsets in RTP streams” an extra bandwidth of 2.88 kbits/s is required, or data rate is to be limited accordingly.

It should be noted that in addition to the exemplary embodiment of the invention shown in the accompanying drawing, the invention may be embodied in different forms and should not be construed as limited to the embodiment set forth herein. Rather, this embodiment is provided so that this disclosure will be thorough and complete, and will fully convey the concept of the invention to those skilled in the art.

1-10. (canceled)

11. A method of estimating transport delay in a communication system that comprises a sender device and a receiver device, the sender device dividing a frame into segments and transmitting each segment to the receiver device in a packet with a send time stamp, the method comprising:
receiving and time stamping packets with a receipt time stamp,
identifying the relative position of packets in a frame,
calculating an offset of one or more packets in the frame, and
performing transport delay analysis based on the send time stamp, the receipt time stamp, and the calculated offset of the one or more packets.

12. The method of claim 11, wherein calculating an offset of one or more packets in the frame comprises calculating the offset based on the relative position of those one or more packets in the frame.

13. The method of claim 11, wherein the offset Oᵢ for a packet i is given by
$${O}_{i} = {k}_{i} * \frac{{T}_{frame}}{N} ,$$
where kᵢ indicates the relative position of the packet in the frame, T_{frame} is the frame interval, and N is the number of packets in the frame.

14. The method of claim 13, wherein kᵢ is given by
kᵢ=N−P_{M}+Pᵢ,
where N is the number of packets in the frame, P_{M} is the sequence number for the last packet in the frame, and Pᵢ is the sequence number for packet i.

15. The method of claim 11, wherein performing transport delay analysis comprises performing the analysis based on the time difference D_{i,j} between transmission times for two packets i and j, wherein D_{i,j} is given by
D_{i,j}=(Rⱼ−Rᵢ)−((Sⱼ+Oⱼ)−(Sᵢ+Oᵢ),)
where Rⱼ and Rᵢ are receipt time stamps of packets j and i, respectively, Sⱼ and Sᵢ are send time stamps of packets j and i, respectively, and Oⱼ and Oᵢ are offsets of packets j and i, respectively.

16. The method of claim 15, wherein the offset Oᵢ for a packet i is given by
$${O}_{i} = {k}_{i} * \frac{{T}_{frame}}{N} ,$$
where kᵢ indicates the relative position of the packet i in the frame, T_{frame} is the frame interval, and N is the number of packets in the frame.

17. The method of claim 16, wherein kᵢ is given by
kᵢ=N−P_{M}+Pᵢ,
where N is the number of packets in the frame, P_{M} is the sequence number for the last packet in the frame, and Pᵢ is the sequence number for packet i.

18. The method of claim 11, wherein the packets are RTP packets.

19. A receiver device of a communication system, comprising:
a network interface adapted to receive and time stamp packets with a receipt time stamp; and
a processing circuit adapted to identify the relative position of packets in a frame, calculate an offset of one or more packets in the frame, and perform transport delay analysis based on the send time stamp, the receipt time stamp, and the calculated offset of the one or more packets.

20. The receiver device of claim 19, wherein the processing circuit is adapted to calculate an offset of one or more packets in the frame based on the relative position of those one or more packets in the frame.

21. The receiver device of claim 19, wherein the offset Oᵢ for a packet i is given by
$${O}_{i} = {k}_{i} * \frac{{T}_{frame}}{N} ,$$
where kᵢ indicates the relative position of the packet in the frame, T_{frame} is the frame interval, and N is the number of packets in the frame.

22. The receiver device of claim 21, wherein kᵢ is given by
kᵢ=N−P_{M}+Pᵢ,
where N is the number of packets in the frame, P_{M} is the sequence number for the last packet in the frame, and Pᵢ is the sequence number for packet i.

23. The receiver device of claim 19, wherein the processing circuit is adapted to perform the transport delay analysis based on the time difference D_{i,j} between two packets i and j, wherein D_{i,j} is given by
D_{i,j}=(Rⱼ−Rᵢ)−((Sⱼ+Oⱼ)−(Sᵢ+Oᵢ),)
where Rⱼ and Rᵢ are receipt time stamps of packets j and i, respectively, Sⱼ and Sᵢ are send time stamps of packets j and i, respectively, and Oⱼ and Oᵢ are offsets of packets j and i, respectively.

24. The receiver device of claim 23, wherein the offset Oᵢ for a packet i is given by
$${O}_{i} = {k}_{i} * \frac{{T}_{frame}}{N} ,$$
where kᵢ indicates the relative position of the packet in the frame, T_{frame} is the frame interval, and N is the number of packets in the frame.

25. The receiver device of claim 24, wherein kᵢ is given by
kᵢ=N−P_{M}+Pᵢ,
where N is the number of packets in the frame, P_{M} is the sequence number for the last packet in the frame, and Pᵢ is the sequence number for packet i.

26. The receiver device of claim 19, wherein the packets are RTP packets.
